(19) United States
(12) Patent Application Publication
(10) Pub. No.: US 2022/0092509 A1
(43) Pub. Date: Mar. 24, 2022

(54) Work Improvement Support Apparatus, and Work Improvement Support System

(71) Applicant: Hitachi, Ltd., Tokyo (JP)

(72) Inventors: Yuuichi SUGINISHI, Tokyo (JP); Toru TANAKA, Tokyo (JP); Takafumi CHIDA, Tokyo (JP)

(21) Appl. No.: 17/210,775

(22) Filed: Mar. 24, 2021

(30) Foreign Application Priority Data
Sep. 23, 2020 (JP) 2020-159001

(51) Int. Cl. G06Q 10/06; G06Q 50/04

(52) U.S. Cl. CPC G06Q 10/06393; G06Q 10/0633; G06Q 50/04; G06Q 10/063114; G06Q 10/0637

(57) ABSTRACT

What is provided includes a storage unit configured to store a production result, a production plan and user information for each manufacture manufactured in a manufacturing site, an improvement target extraction unit configured to analyze a combination of the production result and the production plan and extract an element which becomes a target to be improved, an improvement measure estimation unit configured to estimate an improvement measure effective for the element which becomes the target to be improved from an analysis result of the production result and the production plan, and an analysis result generation unit configured to specify predetermined layout using attribute information included in the user information and generate a screen which provides the target to be improved and an improvement measure to a user in accordance with the layout.

### BACKGROUND

### Technical Field

The present invention relates to a work improvement support apparatus and a work improvement support system.

### Related Art

JP 2020-95440 discloses estimating current work conditions for a production facility at a manufacturing site using a work model in which result data and work content of both the production facility and a worker are associated with each other and generating and displaying a recommended work for improving various key performance indicators (KPIs) such as quality and productivity of a product and manufacturing cost.

### SUMMARY

The technology disclosed in JP 2020-95440 takes into account a manufacture such as a product and a part associated with the production facility and the worker who handles the production facility in the work model. However, there remain insufficient points in terms of improvement of KPIs for a shop and a line which are generic concept of the production facility, and, further, the whole factory which is further generic concept. For example, the technology takes into account only a worker who is in charge of the production facility, that is, a single user as a target user in generation and display of the recommended work and does not take into account a case where a plurality of people implements improvement measures. To improve KPIs for a shop and a line which are generic concept of the production facility, and, further, for the whole factory which is further generic concept, there is a case where improvement measures based on an analysis result are communicated to a plurality of people who engages in different fields and different works, which requires attention to a communication method in accordance with a communication destination. However, J P 2020-95440 A does not take into account this point.

An object of the present invention is to utilize a result obtained through analysis using shop-floor data (4M data: man, machine, material and method) as improvement measures and appropriately communicate the measures for each of people who engage in different fields and different works.

The present application includes means for solving at least part of the above-described problem, for example, as follows. In order to solve the above problem, a work improvement support apparatus according to an aspect of the present invention includes a storage unit configured to store a production result, a production plan and user information for each manufacture manufactured in a manufacturing site, an improvement target extraction unit configured to analyze a combination of the production result and the production plan and extract an element which becomes a target to be improved, an improvement measure estimation unit configured to estimate an improvement measure effective for the element which becomes the target to be improved from an analysis result of the production result and the production plan, and an analysis result generation unit configured to specify predetermined layout using attribute information included in the user information and generate a screen which provides the target to be improved and an improvement measure to a user in accordance with the layout.

According to the present invention, it becomes possible to utilize a result obtained through analysis using shop-floor data as improvement measures and appropriately communicate the measures for each of people who engage in different fields and different works. Problems other than those described above, configurations and effects will become clear from the following detailed description.

### BRIEF DESCRIPTION OF DRAWINGS

FIG. 1 is a view illustrating a configuration example of a work improvement support system according to a first embodiment of the present invention;

FIG. 2 is a view illustrating a configuration example of a work improvement support apparatus;

FIG. 3 is a view illustrating an example of a data structure in a production result storage unit;

FIG. 4 is a view illustrating an example of a data structure in a production plan storage unit;

FIG. 5 is a view illustrating an example of a data structure in a KPI analysis scheme storage unit;

FIG. 6 is a view illustrating an example of a data structure in a problem element storage unit;

FIG. 7 is a view illustrating an example of a data structure in an improvement target storage unit;

FIG. 8 is a view illustrating an example of a data structure in an improvement measure storage unit;

FIG. 9 is a view illustrating an example of a data structure in a user information storage unit;

FIG. 10 is a view illustrating a hardware configuration example of the work improvement support apparatus;

FIG. 11 is a view illustrating an example of flow of problem element specification processing;

FIG. 12 is a view illustrating an example of flow of improvement target extraction processing;

FIG. 13 is a view illustrating an example of flow of improvement measure estimation processing;

FIG. 14 is a view illustrating an example of flow of process improvement measure estimation processing;

FIG. 15 is a view illustrating an example of flow of production facility improvement measure estimation processing;

FIG. 16 is a view illustrating an example of flow of analysis result generation processing;

FIG. 17 is a view illustrating an example of flow of analysis result (summary) generation processing;

FIG. 18 is a view illustrating an example of an analysis result summary display screen; and

FIG. 19 is a view illustrating an example of a general-purpose analysis result display screen.

### DETAILED DESCRIPTION

An embodiment according to the present invention will be described below on the basis of the drawings. Note that the same reference numerals will be assigned to the same members in principle in all drawings for explaining the embodiment, and repetitive description will be omitted. Further, in the following embodiment, it goes without saying that components (including elements steps, and the like) are not always essential unless they are specifically clearly specified or unless they are obviously essential in principle. Further, it goes without saying that description of “constituted with A”, “formed with A”, “having A” and “including A” does not exclude other elements unless it is clearly specified that they indicate only the elements. In a similar manner, in the following embodiment, shapes, positional relationship, and the like, of the components include those practically close to or similar to the shapes, or the like, unless it is specifically clearly specified or unless it can be considered that the shapes, and the like, are obviously not included in principle.

A factory of a company which runs manufacturing business often makes a future production plan for products to be produced on the basis of production facilities to be used in respective production processes and time of input to the production facilities and performs daily production activity in accordance with the production plan. At such a manufacturing site, various large and small delays occur in the plan due to various factors such as workers, facilities and a manufacture itself.

Particularly, in an environment where a variety of types of products are produced, and a mixture ratio of the types varies from hour to hour, a wide variety of manufacturing processes are required in accordance with the types, and the manufacturing processes are complicated. Thus, it tends to be difficult to predict events which are likely to occur in advance.

To know the events which are likely to occur early, it is necessary to correctly acquire and utilize progress of production. Particularly, in a case where types of products vary rapidly, or the like, high analysis ability is required to analyze events which have occurred in the past, extract elements which have caused delays in the plan and implement appropriate and effective improvement measurements for each element. Further, it is also important to communicate the analysis result to a person in charge simply in accordance with a field in which the person engages.

For example, while a person who is responsible for operation of the whole factory is interested in management of resources and improvement while specifying a largely affected range from a viewpoint of KPIs which assess performance of the whole factory, a worker tends to be more interested in efficient use of a production facility to be used in a work which the worker engages in and management of detailed timings of start of works than performance of the whole factory. Thus, a unit in which the improvement measures should be presented or analysis content which becomes a basis for implementing the measures tend to be different.

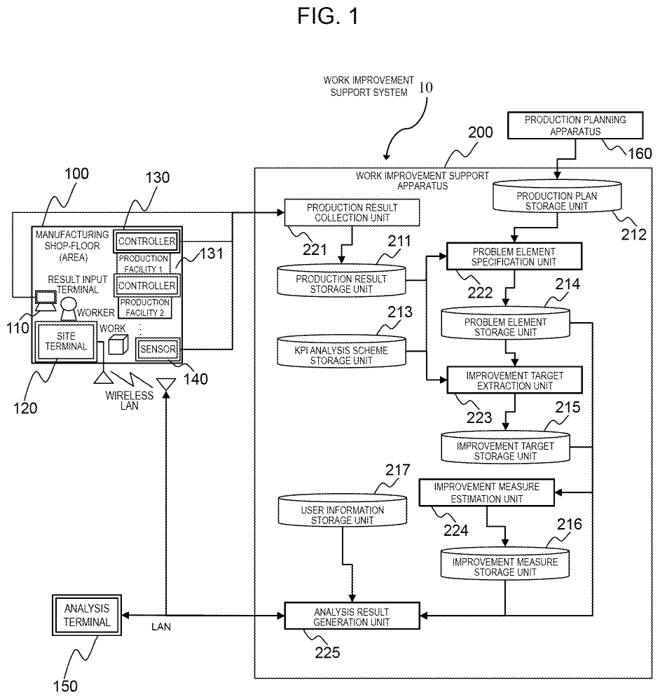

FIG. 1 is a view illustrating a configuration example of a work improvement support system according to a first embodiment of the present invention. A work improvement support system 10 includes production site apparatuses provided in a manufacturing shop-floor (area) 100, an analysis terminal 150 provided outside the manufacturing site, a production planning apparatus 160, and a work improvement support apparatus 200 which is connected to the production site apparatuses and the analysis terminal 150 via a network so as to be able to perform communication.

This network is, for example, a network of one or a composite of a communication network using a local area network (LAN), a wide area network (WAN), a virtual private network (VPN) and a public network such as the Internet as part or the whole of the network, a mobile telephone network, and the like. Note that the network may be a wireless communication network such as Wi-Fi (registered trademark) and 5G (Generation).

The production site apparatuses include a result input terminal 110, a site terminal 120 which displays a work instruction, an analysis result, and the like, a controller 130, a production facility 131, other various kinds of tools and an apparatus such as a sensor 140 which acquires behavior, or the like, of a worker. The result input terminal 110 is a production result collection apparatus which accepts input of an individual identifier of a manufacturing target and result information such as process start time and end time from an operator. The site terminal 120, which is a terminal to be operated by the operator, displays screen information generated by the work improvement support apparatus 200, accepts operation input on the screen and requests processing to the work improvement support apparatus 200.

The controller 130 is an apparatus which controls operation of the production facility 131. The controller 130 monitors information such as start of operation of the production facility 131, an operating state, a non-operating state and time at which operation ends, or the like, and transmits the information to a production result collection unit 221 of the work improvement support apparatus 200 via a network. The production facility 131 is an apparatus to be used for production and is, for example, an apparatus such as a numerical control machining apparatus (NC apparatus). Note that while an example has been described where the controller 130 transmits operation information of the production facility 131 to the work improvement support apparatus 200, the present invention is not limited to this, and the production facility 131 itself may transmit the operation information to the work improvement support apparatus 200.

The sensor 140, which is an apparatus which acquires behavior information of a worker which operates the production facility 131, includes, for example, an acceleration sensor, a camera, a heart rate sensor, and a temperature sensor. The sensor 140 monitors information such as start of operation by the worker, an operating state, a non-operating state and time at which operation ends, or the like, and transmits the information to the production result collection unit 221 of the work improvement support apparatus 200 via a network.

The analysis terminal 150, which is a terminal provided at an arbitrary location inside or outside of the manufacturing site and is operated by an operator, displays the screen information generated by the work improvement support apparatus 200, accepts operation input on the screen and requests processing to the work improvement support apparatus 200.

The production planning apparatus 160 makes a future production plan using manufacturing flow for each type of a product, a list of production facilities of a factory and a maintenance plan, a list of facilities handled by workers, a shift plan of the workers, master information including an operation calendar, or the like, of the factory, information of manufactures in process at scheduled date and time, and information such as a plan of input to the factory. Note that in place of this production planning apparatus 160, an apparatus which accepts production plan data, or the like, from a manufacturing execution system (MES) which is connected to a network and which is not illustrated may be provided.

The work improvement support apparatus 200 performs various kinds of processing such as problem element specification processing, improvement target extraction processing, improvement measure estimation processing and analysis result generation processing using production result information including shop-floor data (4M data: man, machine, material and method) acquired from the result input terminal 110 and the production site apparatuses, and the production plan information.

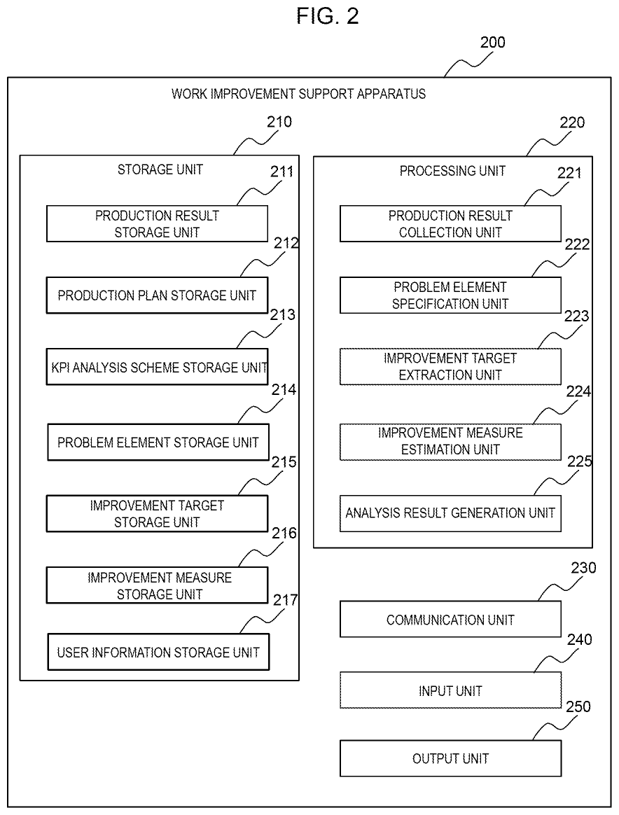

FIG. 2 is a view illustrating a configuration example of a work improvement support apparatus. The work improvement support apparatus 200 includes a storage unit 210, a processing unit 220, a communication unit 230, an input unit 240 and an output unit 250.

The storage unit 210 includes a production result storage unit 211, a production plan storage unit 212, a KPI analysis scheme storage unit 213, a problem element storage unit 214, an improvement target storage unit 215, an improvement measure storage unit 216, and a user information storage unit 217.

The production result storage unit 211 stores information specifying a work (processing) of a process, time at which a work (processing) in the preceding process is completed, time at which the work (processing) is started, time at which the work (processing) is completed, a production facility at which the work (processing) has been performed, and a worker who has performed the work (processing), that is, information which records 4M dynamics of the manufacturing site, for each manufacture such as a part and a product.

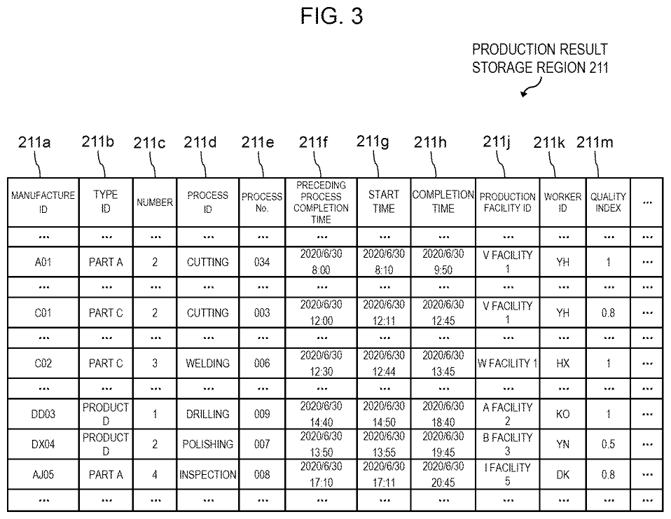

FIG. 3 is a view illustrating an example of a data structure in a production result storage unit. The production result storage unit 211 stores information acquired by the production result collection unit 221 which will be described later from the result input terminal 110 and the manufacturing site apparatuses.

The production result storage unit 211 includes a manufacture ID field 211a, a type ID field 211b, a number field 211c, a process ID field 211d, a process No. field 211e, a preceding process completion time field 211f, a start time field 211g, a completion time field 211h, a production facility ID field 211j, a worker ID field 211k, and a quality index field 211m.

The manufacture ID field 211a, the type ID field 211b, the number field 211c, the process ID field 211d, the process No. field 211e, the preceding process completion time field 211f, the start time field 211g, the completion time field 211h, the production facility ID field 211j, the worker ID field 211k, and the quality index field 211m are associated with one another.

The manufacture ID filed 211a stores information specifying a manufacture ID which is identification information which is capable of uniquely identifying each manufacture such as a product and a part.

The type ID field 211b stores information specifying a type of the manufacture specified in the manufacture ID field 211a.

The number field 211c stores information specifying quantity of a manufacture included in the manufacture specified in the manufacture ID field 211a.

The process ID field 211d stores information for specifying a process in which the manufacture specified in the manufacture ID field 211a is processed.

The process No. field 211e stores information specifying what number of process, a process in the process ID field 211d is from an initial process for the manufacture specified in the manufacture ID field 211a.

The preceding process completion time field 211f stores information specifying time at which the preceding process of the process specified in the process ID field 211d is completed for the manufacture specified in the manufacture ID field 211a.

The start time field 211g stores information specifying time at which the processing of the process specified in the process ID field 211d is started for the manufacture specified in the manufacture ID field 211a.

The completion time field 211h stores information specifying time at which the processing of the process specified in the process ID field 211d is completed for the manufacture specified in the manufacture ID field 211a.

The production facility ID field 211j stores information specifying a production facility ID utilized for processing of the process specified in the process ID field 211d of the manufacture specified in the manufacture ID field 211a during a period from the start time specified in the start time field 211g until the end time specified in the completion time field 211h.

The worker ID field 211k stores information specifying a worker ID of who engaged the processing of the process specified in the process ID field 211d of the manufacture specified in the manufacture ID field 211a during a period from the start time specified in the start time field 211g until the completion time specified in the completion time field 211h.

The quality index field 211m stores quality information for the manufacture specified in the manufacture ID field 211a in the processing of the process specified in the process ID field 211d during a period from the start time specified in the start time field 211g until the completion time specified in the completion time field 211h. Here, the quality information is a predetermined index representing quality such as a yield ratio.

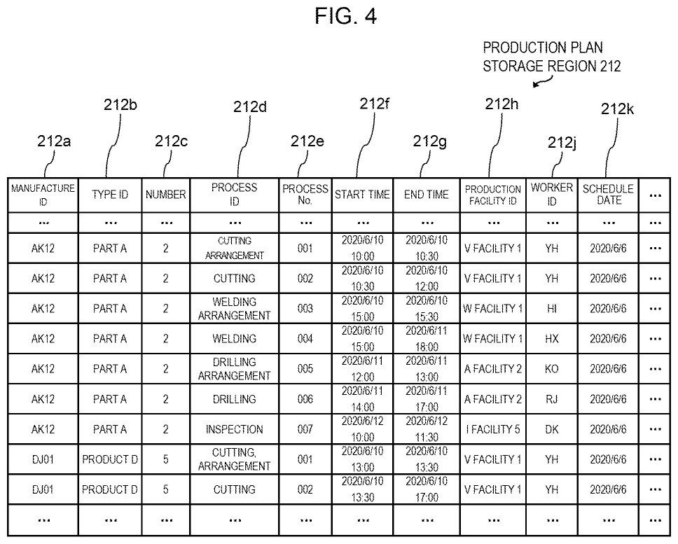

FIG. 4 is a view illustrating an example of a data structure in a production plan storage unit. The production plan storage unit 212 stores a production plan generated by the production planning apparatus 160.

The production plan storage unit 212 includes a manufacture ID field 212a, a type ID field 212b, a number field 212c, a process ID field 212d, a process No. field 212e, a start time field 212f, an end time field 212g, a production facility ID field 212h, a worker ID field 212j, and a scheduled date field 212k.

The manufacture ID field 212a, the type ID field 212b, the number field 212c, the process ID field 212d, the process No. field 212e, the start time field 212f, the end time field 212g, the production facility ID field 212h, the worker ID field 212j, and the scheduled date field 212k are associated with one another.

The manufacture ID filed 212a stores information specifying a manufacture ID which is identification information which is capable of uniquely identifying each manufacture such as a product and a part.

The type ID field 212b stores information specifying a type ID of the manufacture specified in the manufacture ID field 212a.

The number field 212c stores information specifying quantity of a manufacture included in the manufacture specified in the manufacture ID field 212a.

The process ID field 212d stores information for specifying the process ID for identifying a process in which the manufacture specified in the manufacture ID field 212a is processed.

The process No. field 212e stores information specifying what number of process, a process in the process ID field 212d is from an initial process for the manufacture specified in the manufacture ID field 212a.

The start time field 212f stores information specifying time at which the processing of the process specified in the process ID field 212d is scheduled to start for the manufacture specified in the manufacture ID field 212a.

The end time field 212g stores information specifying time at which the processing of the process specified in the process ID field 212d is scheduled to end for the manufacture specified in the manufacture ID field 212a.

The production facility ID field 212h stores information specifying a production facility ID scheduled to be utilized for processing of the process specified in the process ID field 212d of the manufacture specified in the manufacture ID field 212a during a period from the start time specified in the start time field 212f until the end time specified in the end time field 212g.

The worker ID field 212j stores information specifying a worker ID of who is scheduled to engage the processing of the process specified in the process ID field 212d of the manufacture specified in the manufacture ID field 212a during a period from the start time specified in the start time field 212f until the end time specified in the end time field 212g.

The scheduled date field 212k stores information specifying a date at which a plan is scheduled, the plan being a plan for the manufacture specified in the manufacture ID field 212a, which is handled by the worker having the worker ID specified in the worker ID field 212j by utilizing the facility having the facility ID specified in the production facility ID field 212h during a period from the start time specified in the start time field 212f until the end time specified in the end time field 212g in the process specified in the process ID field 212d.

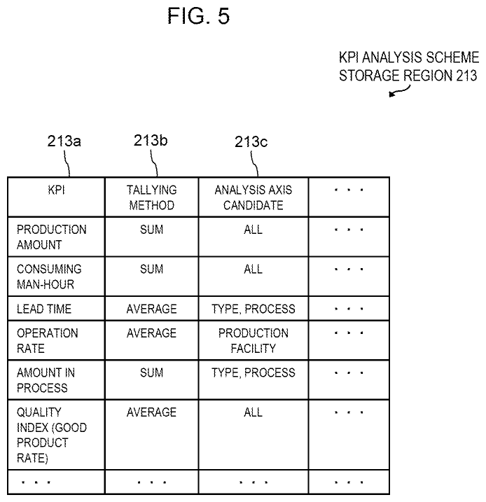

FIG. 5 is a view illustrating an example of a data structure in a KPI analysis scheme storage unit. The KPI analysis scheme storage unit 213 stores information to be utilized by a problem element specification unit 222 and an improvement target extraction unit 223 which will be described later.

The KPI analysis scheme storage unit 213 includes a KPI field 213a, a tallying method field 213b, and an analysis axis candidate field 213c.

The KPI field 213a, the tallying method field 213b and the analysis axis candidate field 213c are associated with one another.

The KPI field 213a stores information specifying a KPI to be used in processing at the work improvement support apparatus 200.

The tallying method field 213b stores information specifying a tallying method in a case where a KPI specified in the KPI field 213a is tallied up with a plurality of periods or with a plurality of elements.

The analysis axis candidate field 213c stores elements which can be set as an analysis axis in a case where the KPI specified in the KPI field 213a is analyzed. Here, in a case where data stored in this analysis axis candidate field 213c is “all”, all the elements handled at the work improvement support apparatus 200 can be set as an analysis axis for the KPI specified in the KPI field 213a.

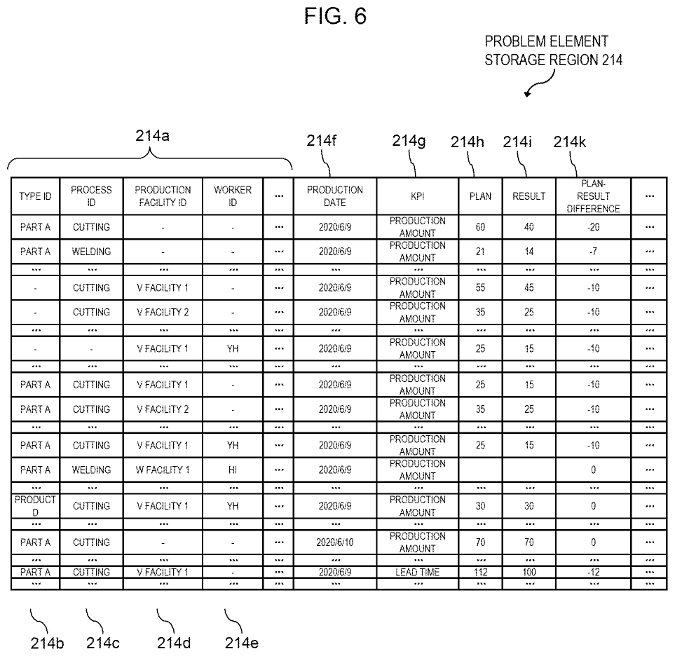

FIG. 6 is a view illustrating an example of a data structure in a problem element storage unit. The problem element storage unit 214 stores information generated by the problem element specification unit 222 which will be described later.

The problem element storage unit 214 includes an element ID field 214a, a production date field 214f, a KPI field 214g, a plan field 214h, a result field 214i, and a plan-result difference field 214k. Further, the element ID field 214a can include a plurality of elements which specify process implementing conditions. Thus, in the present embodiment, a case will be described as a typical example where the element ID field 214a is a combination of a type ID 214b, a process ID 214c, a production facility ID 214d and a worker ID 214e.

The element ID field 214a, the production date field 214f, the KPI field 214g, the plan field 214h, the result field 214i and the plan-result difference field 214k are associated with one another.

The element ID field 214a stores information which is capable of uniquely identifying a combination regarding a plurality of elements regarding production. For example, the element ID field 214a stores a combination of information specifying the type ID, information specifying the process ID, information specifying the production facility ID, and information specifying the worker ID.

The production date field 214f stores information specifying a production date. The KPI field 214g stores information specifying a KPI. The plan field 214h stores a plan value for the KPI designated in the KPI field 214g for the production date designated in the production date field 214f with the combination of elements designated in the element ID field 214a.

The result field 214i stores a result value for the KPI designated in the KPI field 214g for the production date designated in the production date field 214f with the combination of elements designated in the element ID field 214a.

The plan-result difference field 214k stores a difference between the plan and the result for the KPI designated in the KPI field 214g for the production date designated in the production date field 214f with the combination of elements designated in the element ID field 214a. Here, the difference is, for example, information calculated by subtracting a plan value, that is, the numerical value stored in the plan field 214h from a result value, that is, the numerical value stored in the result field 214i or dividing the result value by the plan value. Further, the difference is not limited to this and may be obtained using other methods if the difference is information indicating a difference between the plan and the result using a predetermined method.

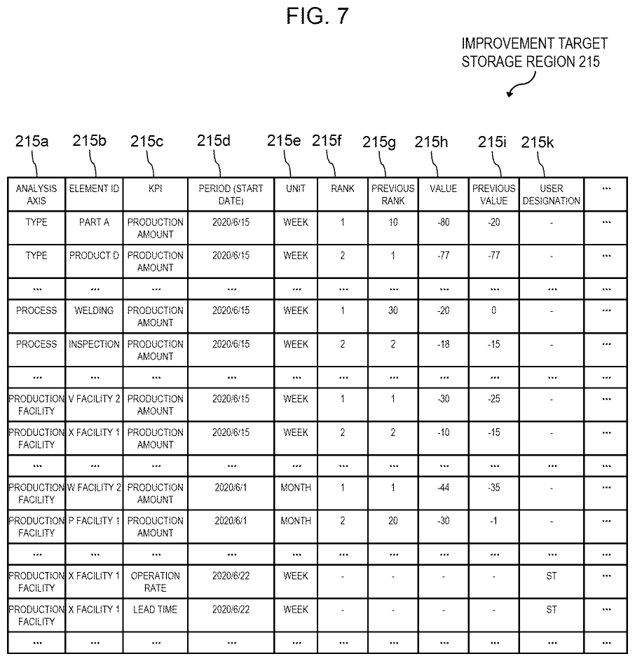

FIG. 7 is a view illustrating an example of a data structure in an improvement target storage unit. The improvement target storage unit 215 stores information generated by the improvement target extraction unit 223 which will be described later, and stores information specifying an element for which divergence occurs between the plan and the result of the KPI during a period designated for each analysis axis, that is, an element for which measures should be taken to improve QCD. Here, the analysis axis is, for example, a viewpoint of analysis such as a type, a process, a production facility and a worker. In the viewpoint of the analysis described above, it can be said that the type, the process, the production facility and the worker respectively correspond to a material, a method, machine and a man in the 4M data.

The improvement target storage unit 215 includes an analysis axis field 215a, an element ID field 215b, a KPI field 215c, a period (start date) field 215d, a unit field 215e, a rank field 215f, a previous rank field 215g, a value field 215h, a previous value field 215i, and a user designation field 215k.

The analysis axis field 215a, the element ID field 215b, the KPI field 215c, the period (start date) field 215d, the unit field 215e, the rank field 215f, the previous rank field 215g, the value field 215h, the previous value field 215i, and the user designation field 215k are associated with one another.

The analysis axis field 215a stores information specifying an analysis axis, that is, a viewpoint of analysis. The element ID field 215b stores information specifying an element ID which becomes a unit of the analysis in the viewpoint of analysis designated in the analysis axis field 215a. In other words, it can be said that the information stored in the analysis axis field 215a indicates characteristics or a group of information stored in the element ID field 215b.

The KPI field 215c stores information specifying a KPI regarding the element ID which becomes a unit of the analysis in the viewpoint of analysis designated in the analysis axis field 215a. The period (start date) field 215d stores information specifying start date of an analysis target period.

The unit field 215e stores information specifying a unit of an analysis period. Here, for example, in a case where the value stored in the unit field is “week”, data to be stored in the rank field 215f and the value field 215h which will be described later are tallied up for seven days starting from the date stored in the period (start date) field 215d.

The rank field 215f stores information specifying a rank at which divergence between the plan and the result is large in the viewpoint designated in the analysis axis field 215a for the element ID designated in the element ID field 215b, that is, a rank for which improvement should be implemented. It can be said that the information stored in the rank field 215f indicates a rank among elements of the same KPI and the same period, and further, of the same analysis axis.

The previous rank field 215g stores information specifying a rank for which improvement should be implemented in the viewpoint designated in the analysis axis field 215a for the element ID designated in the element ID field 215b in the previous tallying period.

The value field 215h stores numerical value information representing a degree of divergence between the plan and the result in the viewpoint designated in the analysis axis field 215a for the element ID designated in the element ID field 215b.

The previous value field 215i stores numerical value information representing a degree of divergence between the plan and the result in the viewpoint designated in the analysis axis field 215a for the element ID designated in the element ID field 215b in the previous tallying period.

The user designation field 215k stores user ID information indicating that the element having the element ID designated in the element ID field 215b is specified as an element to be improved from the analysis result in the viewpoint designated in the analysis axis field 215a.

Here, the user designation field 215k for the data which is generated by the improvement target extraction unit 223 which will be described later and which is stored in the improvement target storage unit 215 is blank. In other words, in a case where some kind of value is input in the user designation field 215k, it is assumed that a given user specifies the element as an improvement target from the analysis result and stores the data. For example, the improvement target is registered via the input unit 240 which will be described later.

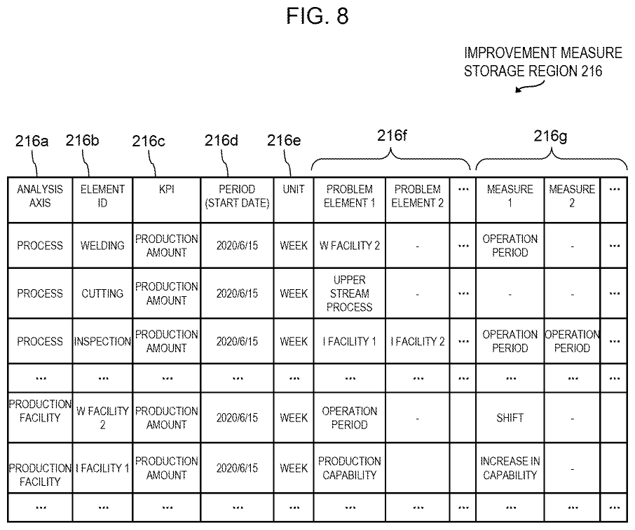

FIG. 8 is a view illustrating an example of a data structure in an improvement measure storage unit. The improvement measure storage unit 216 includes an analysis axis field 216a, an element ID field 216b, a KPI field 216c, a period (start date) field 216d, a unit field 216e, a problem element field 216f, and a measure field 216g.

The analysis axis field 216a, the element ID field 216b, the KPI field 216c, the period (start date) field 216d, the unit field 216e, the problem element field 216f, and the measure field 216g are associated with one another.

The analysis axis field 216a stores information specifying an analysis axis, that is, a viewpoint of analysis. The element ID field 216b stores information specifying an element ID which becomes a unit of the analysis in the viewpoint of analysis designated in the analysis axis field 216a.

The KPI field 216c stores information specifying a KPI regarding the element ID which becomes a unit of the analysis in the viewpoint of analysis designated in the analysis axis field 216a. The period (start date) field 216d stores information specifying start date of an analysis target period.

The unit field 216e stores unit information for the analysis period. Here, for example, in a case where a value stored in the unit field is “week”, data to be stored in the measure field 216g which will be described later is stored for seven days starting from the date stored in the period (start date) field 216d.

The problem element field 216f stores information specifying a problem element which has caused divergence between the plan and the result in the KPI designated in the KPI field 216c during the period designated in the period (start date) field 216d and in the unit field 216e for the element ID designated in the element ID field 216b. Note that in a case where there is a plurality of problem elements, the problem element field 216f stores information respectively specifying the plurality of problem elements.

The measure field 216g stores information specifying measures respectively corresponding to the problem elements stored in the problem element field 216f as estimation results of the improvement measure estimation unit 224.

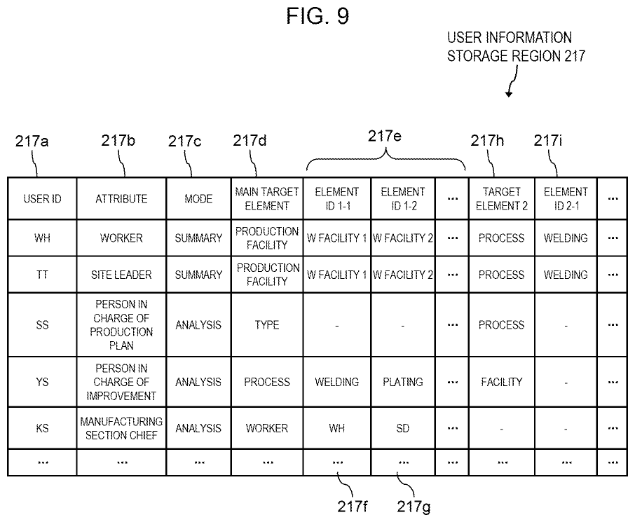

FIG. 9 is a view illustrating an example of a data structure in a user information storage unit. The user information storage unit 217 includes a user ID field 217a, an attribute field 217b, a mode field 217c, a main target element field 217d, an element ID 1 field 217e, a target element 2 field 217h, and an element ID 2 field 217i.

The user ID field 217a, the attribute field 217b, the mode field 217c, the main target element field 217d, the element ID 1 field 217e, the target element 2 field 217h, and the element ID 2 field 217i are associated with one another.

The user ID field 217a stores information specifying the user ID. Note that the user indicates a user of the work improvement support apparatus 200, who is in charge of implementing improvement measures. Further, it is assumed that a plurality of people is in charge of implementing improvement measures and engages in different fields and works.

The attribute field 217b stores information regarding an attribute of the user ID specified in the user ID field 217a. The attribute refers to a predetermined role which specifies a work status or a field the user is in charge of such as, for example, a “worker”, a “site leader”, a “person in charge of production plan”, a “person in charge of improvement” and a “manufacturing section chief”.

The mode field 217c stores information specifying a mode (a type of layout or a screen) of a screen to be utilized by the user specified in the user ID field 217a.

The main target element field 217d stores information regarding a target element which is mainly managed by the user specified in the user ID field 217a. The information regarding the main target element is utilized when the analysis result generation unit 225 generates an analysis result.

The element ID 1 field 217e stores information regarding the element ID indicating breakdown of the element specified in the main target element field 217d. For example, in a case where the element specified in the main target element field 217d is the “production facility”, the element ID 1 field 217e stores information such as “W facility 1” and “W facility 2” which are breakdown of the “production facility” respectively as an element ID 1-1 (217f) and an element ID 1-2 (217g).

The target element 2 field 217h stores information regarding the second and subsequent target elements in a case where there is a plurality of user management targets specified in the user ID field 217a.

The element ID 2 field 217i stores information regarding the element ID indicating breakdown of the element specified in the target element 2 field 217h. For example, in a case where the element specified in the target element 2 field 217h is the “process”, the element ID 2 field 217i stores information such as “welding” and “assembling” which are breakdown of the “process”.

Returning to explanation of FIG. 2, the processing unit 220 of the work improvement support apparatus 200 includes a production result collection unit 221, a problem element specification unit 222, an improvement target extraction unit 223, an improvement measure estimation unit 224, and an analysis result generation unit 225.

The production result collection unit 221 acquires information to be stored in the production result storage unit 211 from the result input terminal 110 at a timing determined in advance (for example, every five seconds) or at a designated timing and updates the information. More specifically, the production result collection unit 221 collects 4M data including results of start and end time of manufacturing processes transmitted from the production site apparatuses via the communication unit 230.

The problem element specification unit 222 specifies problem elements in production. Specifically, the problem element specification unit 222 performs analysis with various perspectives using the production result storage unit 211, the production plan storage unit 212 and the KPI analysis scheme storage unit 213 and stores the result in the problem element storage unit 214.

The improvement target extraction unit 223 extracts elements for which measures should be implemented to solve problems, for example, for each of a type, a process, a production facility, a worker, and the like, to improve productivity and quality. Specifically, the improvement target extraction unit 223 implements analysis with a predetermined perspective using the problem element storage unit 214 and the KPI analysis scheme storage unit 213 and stores the result in the improvement target storage unit 215 along with a quantitative value. For example, the improvement target extraction unit 223 clarifies an improvement target by quantifying and ranking degrees of divergence between plans and results of the KPI for each element in accordance with this perspective of analysis.

The improvement measure estimation unit 224 estimates an improvement measure for improving productivity and quality using the problem element storage unit 214 and the improvement target storage unit 215. For example, the improvement measure estimation unit 224 performs processing of estimating a predetermined improvement measure for the element for which measures should be taken for each of the type, the process, the production facility, the worker, and the like, and stores the estimated improvement measure in the improvement measure storage unit 216. Note that the improvement measure estimation unit 224 compares an operation rate a of the production facility with an operation rate b of the production facility during a period while production conditions are similar, and, in a case where b<=a, determines that the operation rate is tight and estimates increase in production capability as a measure. Meanwhile, in a case where a<b, the improvement measure estimation unit 224 determines that the production facility has capability left over and estimates change of an operation period of the production facility as a measure.

The analysis result generation unit 225 generates a display screen in accordance with the attribute of the user who browses the analysis result using the problem element storage unit 214, the improvement target storage unit 215, the improvement measure storage unit 216, and the user information storage unit 217. The analysis result generation unit 225 transmits work improvement support information to the site terminal 120 or the analysis terminal 150 via a network such as a wireless local area network (LAN) and causes the work improvement support information to be displayed.

The communication unit 230 transmits/receives information to/from other apparatuses via a network. The input unit 240 receives input information which is, for example, displayed and operated on a screen and operated and input with a keyboard or a mouse.

The output unit 250, for example, outputs screen information including information to be output as a result of predetermined processing being performed to the site terminal 120 or the analysis terminal 150 via the communication unit 230.

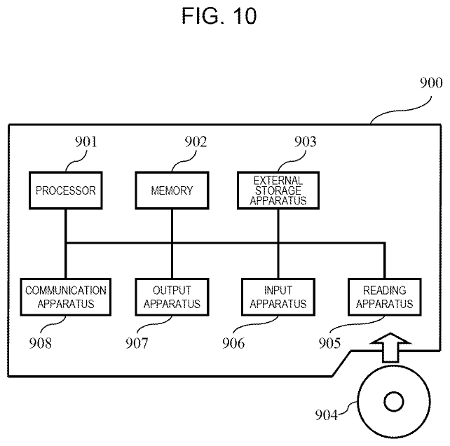

FIG. 10 is a view illustrating a hardware configuration example of the work improvement support apparatus. The work improvement support apparatus 200 can be implemented with a typical computer 900 including a processor (for example, central processing unit (CPU) or a graphics processing unit (GPU)) 901, a memory 902 such as a random access memory (RAM), an external storage apparatus 903 such as a hard disk drive (HDD) and a solid state drive (SSD), a reading apparatus 905 which reads information from a portable storage medium 904 such as a compact disk (CD) and a digital versatile disk (DVD), an input apparatus 906 such as a keyboard, a mouse, a barcode reader and a touch panel, an output apparatus 907 such as a display, and a communication apparatus 908 which performs communication with other computers via a communication network such as a LAN and the Internet, or a network system including a plurality of computers 900. Note that it goes without saying that the reading apparatus 905 can perform writing as well as reading from the portable storage medium 904.

For example, the production result collection unit 221, the problem element specification unit 222, the improvement target extraction unit 223, the improvement measure estimation unit 224 and the analysis result generation unit 225 included in the processing unit 220 can be implemented by a predetermined program stored in the external storage apparatus 903 being loaded to the memory 902 and executed at the processor 901, the input unit 240 can be implemented by the processor 901 utilizing the input apparatus 906, the output unit 250 can be implemented by the processor 901 utilizing the output apparatus 907, the communication unit 230 can be implemented by the processor 901 utilizing the communication apparatus 908, and the storage unit 210 can be implemented by the processor 901 utilizing the memory 902 or the external storage apparatus 903.

This predetermined program may be downloaded from the portable storage medium 904 via the reading apparatus 905 or downloaded from a network via the communication apparatus 908 to the external storage apparatus 903, and then, loaded on the memory 902 and executed by the processor 901. Alternatively, the predetermined program may be directly loaded on the memory 902 from the portable storage medium 904 via the reading apparatus 905 or from the network via the communication apparatus 908 and may be executed by the processor 901.

Note that the result input terminal 110 and the site terminal 120 can also be implemented with the typical computer 900 as illustrated in FIG. 10.

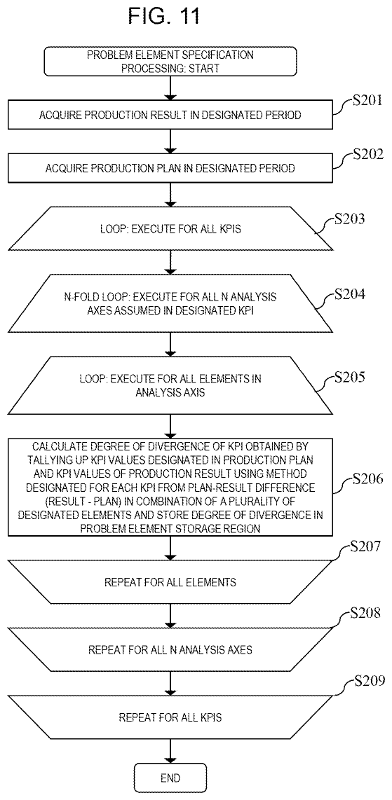

FIG. 11 is a view illustrating an example of flow of problem element specification processing. The problem element specification processing is started at a timing determined in advance (for example, every day) or at a timing at which an instruction to start processing is given to the work improvement support apparatus 200.

First, the problem element specification unit 222 acquires a production result during the designated period from the production result storage unit 211 (step S201).

Then, the problem element specification unit 222 acquires a production plan during the designated period from the production plan storage unit 212 (step S202).

The problem element specification unit 222 then implements processing from step S204 to S208 which will be described later for each of all KPIs stored in the KPI analysis scheme storage unit 213 (step S203, S209).

The problem element specification unit 222 then sets a plurality of analysis axes for the KPI designated in step S203 from the information stored in the analysis axis candidate field 213c of the KPI analysis scheme storage unit 213 and executes N-fold loop on the set N analysis axes (step S204, S208).

The problem element specification unit 222 then implements processing in step S206 which will be described later on all the elements at the analysis axis (step S205, S207).

The problem element specification unit 222 then tallies up KPI values designated in the production plan and KPI values of the production results with a combination of a plurality of designated elements using the tallying method stored in the tallying method field 213b of the KPI analysis scheme storage unit 213, calculates a degree of divergence of the KPI from a difference between the plan and the result (result—plan) and stores the degree of divergence in the problem element storage unit 214 (step S206). More specifically, the problem element specification unit 222 tallies up KPIs for grid points of two elements (such as, for example, the product and the process or the process and the facility) among the 4M data (four production elements) to analyze a difference between the plan and the result and specifies an element corresponding to the grid point at which the divergence is large as a problem element.

For example, in a case where divergence between the plan and the result for the KPI of a process Kf of a product Sb is significantly large, the problem element specification unit 222 further calculates divergence between the plan and the result of KPIs of facilities Mc and Md to be used in the process Kf. Then, in a case where a facility for which divergence is equal to or larger than a predetermined value is found, the problem element specification unit 222 then specifies the facility as the problem element. Then, divergence between the plans and the results of workers Wa and We using the facilities Mc and Md is calculated. Other problem elements relating to the problem element are extracted by relevant problem elements being sequentially extracted in this manner. In other words, 4M data relating to the problem element is clarified and stored in the problem element storage unit 214.

The flow of the problem element specification processing has been described above. According to the problem element specification processing, it is possible to clarify the 4M data having a problem with a KPI and associate the 4M data as a problem element.

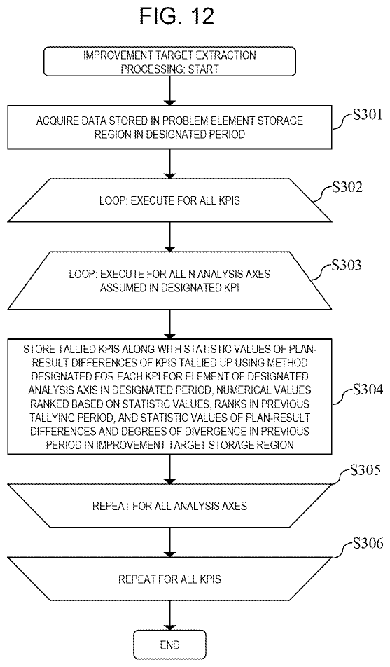

FIG. 12 is a view illustrating an example of flow of improvement target extraction processing. The improvement target extraction processing is started at a timing determined in advance (for example, every day) or at a timing at which an instruction to start processing is given to the work improvement support apparatus 200.

First, the improvement target extraction unit 223 acquires the data stored in the problem element storage unit 214 during the designated period (step S301).

The improvement target extraction unit 223 then implements processing from step S303 to S305 which will be described later for each of all KPIs stored in the KPI analysis scheme storage unit 213 (step S302, S306).

The improvement target extraction unit 223 then sets a plurality of analysis axes for the designated KPI from the information stored in the analysis axis candidate field 213c stored in the KPI analysis scheme storage unit 213 and executes analysis (step S303, S305).

The improvement target extraction unit 223 tallies up KPIs for elements of the designated analysis axes using the tallying method designated in the tallying method field 213b of the KPI analysis scheme storage unit 213 during the designated period and stores the tallied KPIs in the improvement target storage unit 215 along with statistic values of differences between plans and results for the results, numerical values ranked on the basis of the statistic values, ranks in the previous tallying period, and statistic values of the differences between plans and results in the previous period (step S304).

More specifically, the improvement target extraction unit 223 tallies up KPIs for grid points of two elements (such as, for example, the product and the process, the process and the facility or the facility and the worker) among the 4M data (four production elements) to analyze differences between plans and results and quantitatively specifies degrees of problems for each element of the 4M data.

For example, the improvement target extraction unit 223 tallies up the KPIs for the process Kf, the facilities Mc and Md and the workers Wa and We extracted as the problem elements with the respective relevant analysis axes, specifies statistic values of the differences between plans and results, ranks based on the statistics values and ranks in the previous tallying period and stores the statistic values, the ranks and the ranks in the previous tallying period in the improvement target storage unit 215. In this manner, the improvement target extraction unit 223 ranks degrees of the problems of the problem elements so as to quantitatively compare the degrees and stores the ranks in the improvement target storage unit 215.

The example of the flow of the improvement target extraction processing has been described above. According to the improvement target extraction processing, it is possible to quantitatively compare elements which should be improved for each analysis axis such as a type, a process, a production facility and a worker.

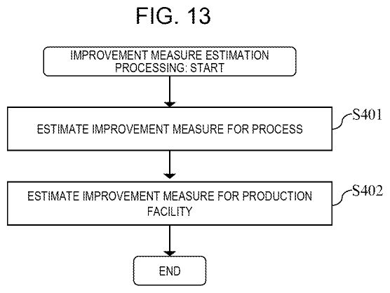

FIG. 13 is a view illustrating an example of flow of improvement measure estimation processing. The improvement measure estimation processing is started at a timing determined in advance (for example, every day) or at a timing at which an instruction to start processing is given to the work improvement support apparatus 200.

First, for the process, the improvement measure estimation unit 224 extracts a process for which an improvement measure needs to be implemented from the data stored in the improvement target storage unit 215, and estimates improvement measures (step S401).

Then, for the production facility, the improvement measure estimation unit 224 extracts a facility for which an improvement measure needs to be implemented from the data stored in the improvement target storage unit 215 and estimates improvement measures (step S402).

The example of the flow of the improvement measure estimation processing has been described above. According to the improvement measure estimation processing, it is possible to plan a measure for improving the element extracted as an improvement target, particularly, a process and a production facility.

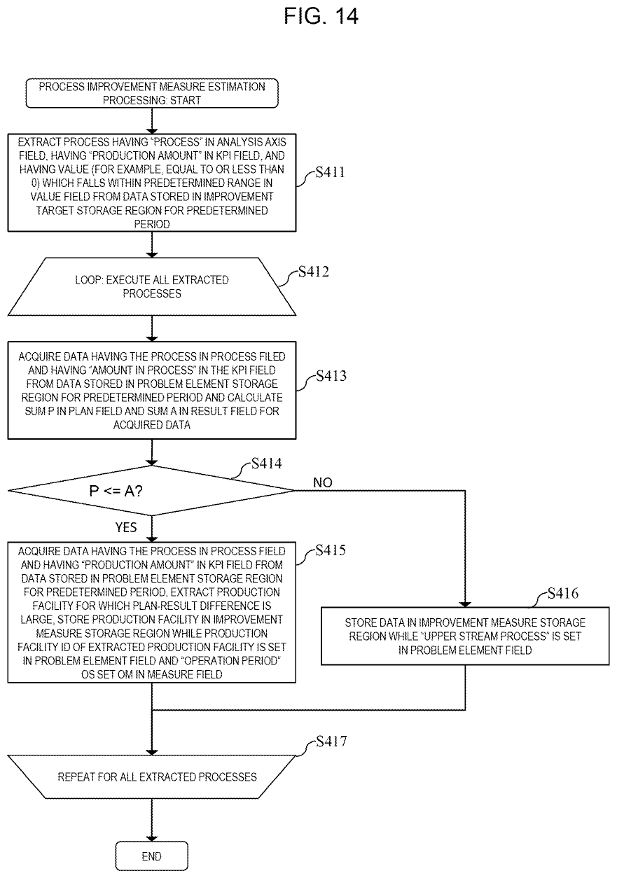

FIG. 14 is a view illustrating an example of flow of process improvement measure estimation processing. In the process improvement measure estimation processing, in a case where a result does not reach a planned amount of the process, the improvement measure estimation unit 224 judges that it is necessary to improve an upper process, while, in a case where the result exceeds the planned amount of the process, the improvement measure estimation unit 224 estimate a measure to increase processing capability such as extension of an operation period of the process.

First, the improvement measure estimation unit 224 extracts a process having a value of “process” in the analysis axis field 215a, having a value of “production amount” in the KPI field 215c and having a value belonging to a predetermined range (for example, equal to or less than zero) in the value field 215h from the data stored in the improvement target storage unit 215 for a predetermined period (step S411).

The improvement measure estimation unit 224 then executes processing from step S413 to S416 which will be described later for all the extracted processes (step S412, S417).

The improvement measure estimation unit 224 acquires data having a value of the process in the process ID field and having a value of “amount in process” in the KPI field 214g from the data stored in the problem element storage unit 214 for the predetermined period and calculates a sum P of the plan field 214h and a sum A of the result field 214i for the acquired data (step S413).

The improvement measure estimation unit 224 compares the sum P of the plan field 214h with the sum A of the result field 214i, and, in a case where P<=A, makes control proceed to step S415, otherwise, makes control proceed to step S416 (step S414).

In a case where P<=A (step S414: Yes), the improvement measure estimation unit 224 acquires data having the process ID of the process and having a value of “production amount” in the KPI field 214g from the data stored in the problem element storage unit 214 for the predetermined period, extracts a production facility for which a difference between the plan and the result is large (a negative value in the plan-result difference field 214k is great), that is, a production facility for which the result does not reach the plan, and stores the production facility in the improvement measure storage unit 216 while the production facility ID of the extracted production facility is set in the problem element field 216f and “operation period” is set in the measure field 216g (step S415).

In a case where P is not equal to or less than A (step S414: No), the improvement measure estimation unit 224 stores data in the improvement measure storage unit 216 while “upper stream process” is set in the problem element field 216f (step S416).

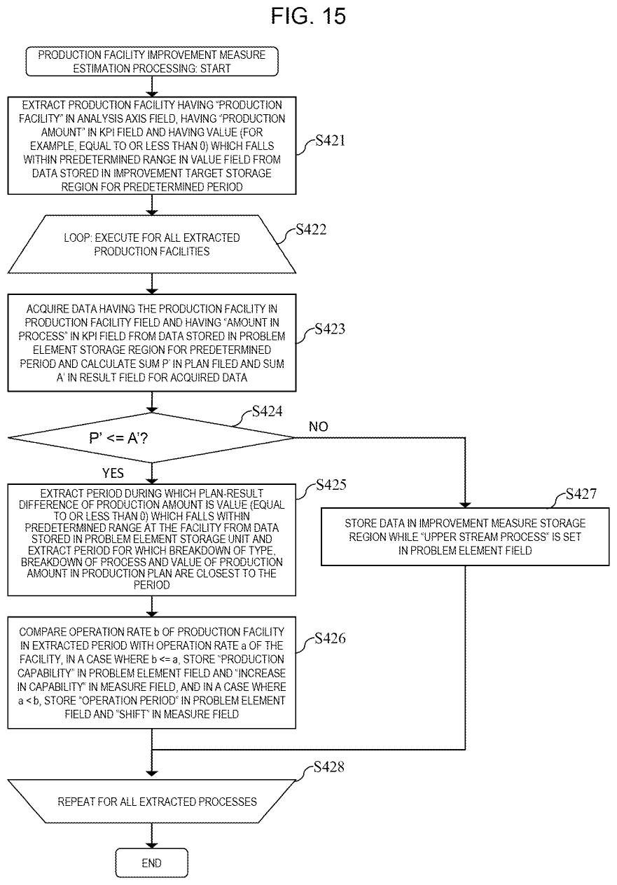

FIG. 15 is a view illustrating an example of flow of production facility improvement measure estimation processing. First, the improvement measure estimation unit 224 extracts a production facility having a value of “production facility” in the analysis axis field 215a, having a value of “production amount” in the KPI field 215c and having a value (the plan-result difference) belonging to a predetermined range (for example, equal to or less than zero) in the value field 215h from the data stored in the improvement target storage unit 215 for a predetermined period (step S421). In other words, the improvement measure estimation unit 224 specifies a production facility for which a KPI of the production amount falls below the plan.

The improvement measure estimation unit 224 then executes processing from step S423 to S427 which will be described later for all the extracted production facilities (step S422, S428).

The improvement measure estimation unit 224 acquires data having a production facility ID of the production facility and having a value of “amount in process” in the KPI field 214g from the data stored in the problem element storage unit 214 for the predetermined period and calculates a sum P′ of the value of the plan field 214h and a sum A′ of the value of the result field 214i for the acquired data (step S423).

The improvement measure estimation unit 224 compares the sum P′ of the value of the plan field 214h with the sum A′ of the value of the result field 214i, and, in a case where P′<=A′, makes control proceed to step S425, otherwise, makes control proceed to step S427 (step S424).

In a case where P′<=A′ (step S424: Yes), the improvement measure estimation unit 224 extracts periods during which the difference between the plan and the result of the production amount falls within a predetermined range (for example, equal to or greater than zero) at the facility from the data stored in the problem element storage unit 214 and extracts a period for which breakdown of the type, breakdown of the process and a value of the production amount in the production plan are the closest to those of the period among the periods (step S425).

The improvement measure estimation unit 224 then compares an operation rate b of the production facility during the extracted similar period with an operation rate a of the facility, and, in a case where b<=a, determines that the operation rate is tight and stores “production capability” in the problem element field 216f of the improvement measure storage unit 216 and stores “increase in capability” in the measure field 216g. Meanwhile, in a case where a<b, the improvement measure estimation unit 224 determines that the production facility has capability left over and stores “operation period” in the problem element field 216f and stores “shift” in the measure field 216g (step S426).

In a case where P′ is not equal to or less than A′ (step S424: No), the improvement measure estimation unit 224 stores “upper stream process” in the problem element field 216f of the improvement measure storage unit 216 (step S427).

The example of the flow of the improvement measure estimation processing for the process and the production facility has been described above. According to the improvement measure estimation processing, it is possible to estimate an improvement measure for each process and production facility.

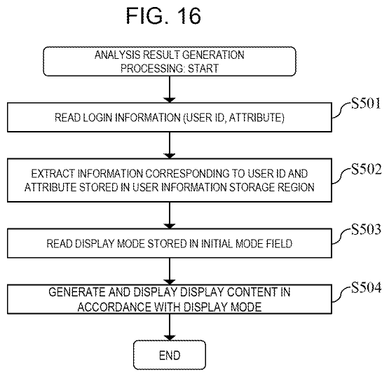

FIG. 16 is a view illustrating an example of flow of analysis result generation processing. The analysis result generation processing is started at a timing determined in advance (for example, every day) or at a timing at which an instruction to start processing is given to the work improvement support apparatus 200.

First, the analysis result generation unit 225 reads login information regarding a user such as a user ID and an attribute (step S501).

The analysis result generation unit 225 then extracts information corresponding to the user ID and the attribute of the user stored in the user information storage unit 217 (step S502).

The analysis result generation unit 225 then reads information in the mode field 217c in the extracted information (step S503).

The analysis result generation unit 225 then generates display content in accordance with the read display mode and generates and outputs the display content as a display screen (step S504).

The example of the flow of the analysis result generation processing has been described above. According to the analysis result generation processing, it is possible to display the analysis result in accordance with an attribute of a user who is logging in.

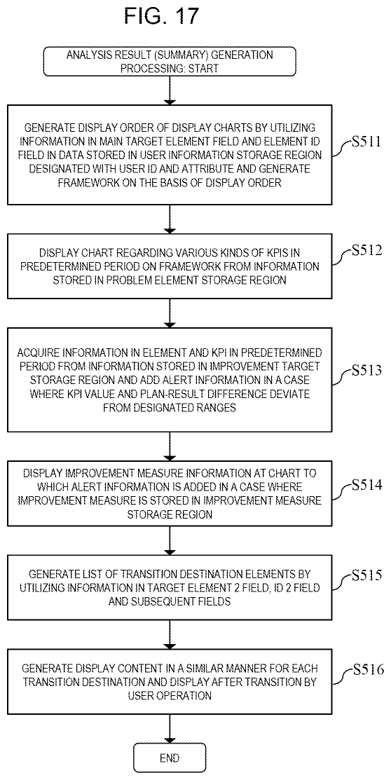

FIG. 17 is a view illustrating an example of flow of analysis result (summary) generation processing. FIG. 17 is a view illustrating an example of detailed flow in step S504 in a case where a summary mode is selected in the analysis result generation processing.

The analysis result generation unit 225 generates a display order of charts to be displayed by utilizing information in the main target element field 217d and the element ID 1 field 217e in the data stored in the user information storage unit 217 designated with the user ID and the attribute and generates predetermined layout information for display on the basis of the display order (step S511).

The analysis result generation unit 225 then displays a chart regarding various kinds of KPIs in a predetermined period on layout from the information stored in the problem element storage unit 214 (step S512).

The analysis result generation unit 225 then acquires information for the elements and the KPIs in the predetermined period from the information stored in the improvement target storage unit 215 and in a case where a value of the KPI and a differences between the plan and the result deviate from designated ranges, adds alert information (step S513).

The analysis result generation unit 225 then displays improvement measure information in a case where improvement measures are stored in the improvement measure storage unit 216 at the chart in which the alert information is added (step S514).

The analysis result generation unit 225 then generates a list of transition destination elements by utilizing information in the target element 2 field 217h, the element ID 2 field 217i and subsequent field in the user information storage unit 217 (step S515).

The analysis result generation unit 225 then generates display content for each transition destination in a similar manner to the above-described processing from step S512 to step S514 and displays the display content after transition by user operation (step S516).

The example of the flow of the analysis result (summary) generation processing has been described above. According to the analysis result (summary) generation processing, it is possible to specify layout information for each attribute of the user and allow the user to confirm items which should be confirmed in descending order of necessity in operation in accordance with a management target or a work target of the user, which contributes to improvement in productivity or quality by quick improvement, so that it is possible to improve key performance indicators (KPIs).

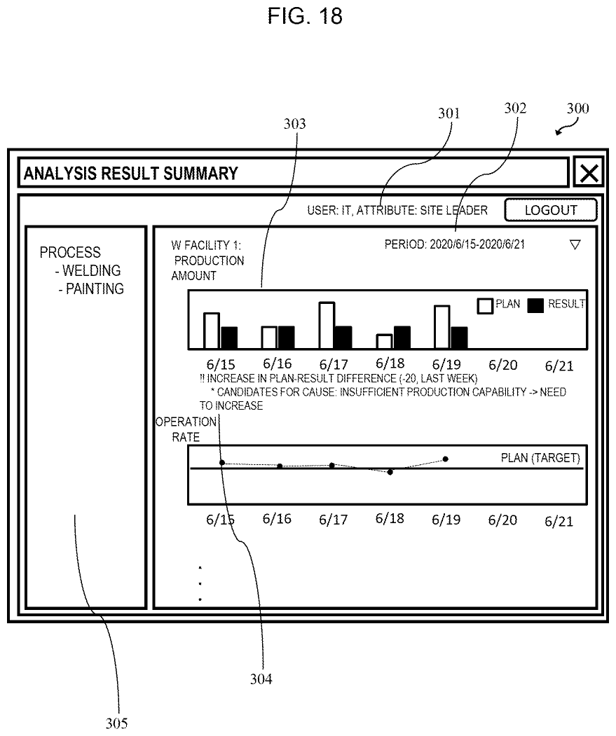

FIG. 18 is a view illustrating an example of an analysis result summary display screen. An analysis result summary display screen 300 is an example of the analysis result summary display screen to be confirmed by a worker or a site leader. On the analysis result summary display screen 300, user input is accepted in a user ID and attribute information input field 301 and a display period input field 302. Display content of a chart display region 303, a cause candidate display region 304 and the other operation selection region 305 is updated in accordance with the input.

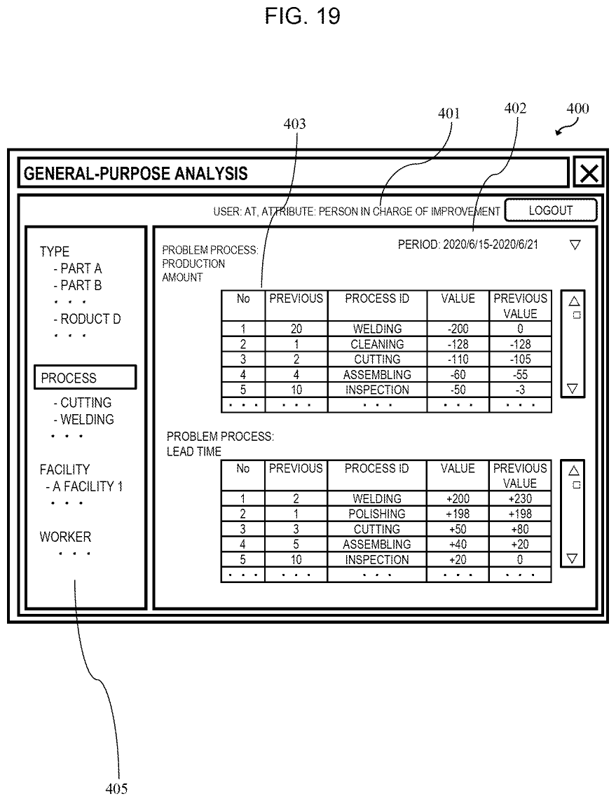

FIG. 19 is a view illustrating an example of a general-purpose analysis result display screen. FIG. 19 illustrates an example of analysis results to be confirmed by a person in charge of improvement on an analysis result display screen 400. On the analysis result display screen 400, user input is accepted in a user ID and attribute information input field 401 and a display period input field 402. Display content of a chart display region 403 and the other operation selection region 405 is updated in accordance with the input.

In this manner, while a plurality of pieces of information can be generally read from a general-purpose analysis result display screen, the general-purpose analysis result display screen provides a wide variety of information amounts and assumes that the user has necessary knowledge and ability to think for appropriately reading the information. In contrast, the analysis result summary display screen which is confirmed by the worker or the site leader displays a right amount of information appropriate for the attribute of the user, so that the user can appropriately obtain the information amount, which is likely to lead to implementation of improvement. In other words, the general-purpose analysis result display screen requires high analysis ability to implement appropriate and effective improvement measures for each element. The analysis result summary display screen enables the analysis result to be communicated in a way it is easy to understand in accordance with the field of the person in charge.

The configuration example of the work improvement support system according to the first embodiment of the present invention has been described above. According to the work improvement support system 10 according to the first embodiment, it is possible to specify a problem point in manufacturing using site data and enable each person in charge to improve the problem point while specifically imagining the problem point.

The above embodiments are described in detail in a way it is easy to understand and does not necessarily limit the present invention to an invention including all the described components. Part of the configuration in the embodiment can be replaced with another configuration and, further, configurations in other embodiments can be added to the configuration in the embodiment. Further, part of the configuration in the embodiment can be deleted.

Further, part or all of the above-described units, components, functions, processing units, and the like, may be implemented with hardware by, for example, being designed with integrated circuits. Further, the above-described units, components, functions, and the like, may be implemented with software by a processor interpreting and executing programs which implement respective functions. Information regarding programs which implement respective functions, tables, files, and the like, can be put in a recording apparatus such as a memory and a hard disk or a recording medium such as an IC card, an SD card and a DVD.

Further, while the above-described embodiment describes that the site data is 4M data of man, machine, material and method, the site data is not limited to this. For example, the site data may be 5M data (4M data+measure), 5M+E data (5M data+environment).

Note that control lines and information lines which are considered to be necessary for description are described in the above-described embodiment, and not all the control lines and the information lines in manufacturing are necessarily described. Actually, substantially all the components are connected to one another. The embodiment of the present invention has been mainly described above.

What is claimed is:

1. A work improvement support apparatus comprising:
a storage unit configured to store a production result, a production plan and user information for each manufacture manufactured in a manufacturing site;
an improvement target extraction unit configured to analyze a combination of the production result and the production plan and extract an element which becomes a target to be improved;
an improvement measure estimation unit configured to estimate an improvement measure effective for the element which becomes the target to be improved from an analysis result of the production result and the production plan; and
an analysis result generation unit configured to specify predetermined layout using attribute information included in the user information and generate a screen which provides the target to be improved and an improvement measure to a user in accordance with the layout.

2. The work improvement support apparatus according to claim 1, wherein
the improvement target extraction unit
extracts an element for which a measure is to be implemented to solve a problem for each of a type, a process, a production facility, a worker, and the like, of the manufacture.

3. The work improvement support apparatus according to claim 1, wherein
the improvement target extraction unit
clearly extracts an improvement target by quantifying and ranking a degree of divergence between a plan and a result of a KPI for each element for each of a type, a process, a production facility, a worker, and the like, of the manufacture.

4. The work improvement support apparatus according to claim 1, further comprising:
a problem element specification unit configured to analyze a difference between a plan and a result by tallying up KPIs for grid points of two elements among 4M data and specify an element corresponding to a grid point with greater divergence as a problem element, wherein
the improvement target extraction unit extracts the element which becomes the target to be improved by narrowing down to the problem element.

5. The work improvement support apparatus according to claim 1, wherein
the improvement measure estimation unit
judges that improvement of an upper process is required for a process for which a result does not reach a planned amount and estimates a measure to increase processing capability of a process for a process for which a result exceeds a planned amount.

6. The work improvement support apparatus according to claim 1, wherein
the improvement measure estimation unit
compares an operation rate a of a production facility with an operation rate b of a production facility in a period of a similar production condition, in a case where b<=a, estimates increase in production capability as a measure, and, in a case where a<b, estimates change of an operation period of the production facility as a measure.

7. A work improvement support system comprising: a work improvement support apparatus; a production facility at a manufacturing site; a sensor provided at the manufacturing site; and a site terminal provided at a site and configured to display an output result of the work improvement support apparatus, wherein
the production facility transmits history of an operating state to the work improvement support apparatus,
the sensor transmits detection information to the work improvement support apparatus, and
the work improvement support apparatus includes:
a communication unit configured to perform communication with each of the production facility, the sensor and the site terminal;
a storage unit configured to store a collected history of the operating state, the detection information, a production plan and user information;
an improvement target extraction unit configured to analyze the history of the operating state and the production plan in combination and extract an element which becomes a target to be improved;
an improvement measure estimation unit configured to estimate an improvement measure effective for the element which becomes the target to be improved from an analysis result of the history of the operating state and the production plan; and
an analysis result generation unit configured to specify predetermined layout using attribute information included in the user information and generate a screen which provides the target to be improved and an improvement measure to a user in accordance with the layout.

8. A work improvement support method using a work improvement support system which includes: a work improvement support apparatus; a production facility at a manufacturing site; a sensor provided at the manufacturing site; and a site terminal provided at a site and configured to display an output result of the work improvement support apparatus,
the production facility transmitting history of an operating state to the work improvement support apparatus,
the sensor transmitting detection information to the work improvement support apparatus,
the work improvement support apparatus including:
a communication unit configured to communicate with each of the production facility, the sensor and the site terminal; and
a storage unit configured to store a collected history of the operating state, the detection information, a production plan and user information, the work improvement support method comprising:
an improvement target extraction step of analyzing the history of the operating state and the production plan in combination and extracting an element which becomes a target to be improved;
an improvement measure estimation step of estimating an improvement measure effective for the element which becomes the target to be improved from an analysis result of the history of the operating state and the production plan; and
an analysis result generation step of specifying predetermined layout using attribute information included in the user information and generating a screen which provides the target to be improved and an improvement measure to a user in accordance with the layout.
